(19) United States
(12) Patent Application Publication
(10) Pub. No.: US 2024/0201671 A1
(43) Pub. Date: Jun. 20, 2024

(54) INTELLIGENT WORKFLOW ASSISTANCE SYSTEMS FOR PRODUCTION PROCESSES

(71) Applicant: ANCORA MOBILE SL, Vigo (ES)

(72) Inventors: Francisco Javier Gonzalez Castano, Vigo (ES); Alexandre Bastos Fernandez, Redondela (ES); Felipe Jose Gil Castineira, Abadin (ES); Diego Celix Salgado, Vigo (ES)

(73) Assignee: ANCORA MOBILE SL, Vigo (ES)

(21) Appl. No.: 18/545,701

(22) Filed: Dec. 19, 2023

Related U.S. Application Data
(60) Provisional application No. 63/433,974, filed on Dec. 20, 2022.

(51) Int. Cl. G05B 19/418

(52) U.S. Cl. CPC G05B 19/41865; G05B 2219/31449

(57) ABSTRACT

Workflow assistance systems for a production process including a mobile terminal, a static terminal, a production management server, and a workflow server. The mobile terminal, the static terminal, the production management server, and the workflow server are in data communication with the data network. The mobile terminal supports a first multimodal user interface of options for controlling operation of a production area. The first multimodal user interface provides instructions to and receives instructions from a worker. The static terminal supports a second multimodal user interface of options for controlling operation of the production area. The production management server runs production operations management software and provides instructions for the second multimodal user interface of the static terminal. The workflow server executes workflow server instructions to determine workflow assistance instructions that assist the worker to operate the production area via the first multimodal user interface of the mobile terminal.

### CROSS REFERENCE TO RELATED APPLICATIONS

This application claims priority to copending Provisional U.S. Application, Ser. No. 63/433,974, filed on Dec. 20, 2022, which is hereby incorporated by reference for all purposes.

### BACKGROUND

The present disclosure relates generally to workflow assistance systems. In particular, intelligent workflow assistance systems to improve the performance of a worker in a production process are described.

Workflow assistance systems typically employ software supporting various interfaces to improve the performance of workers who perform activities at different points or stages throughout a workflow. The workflow may involve different spatial positions and may include utilizing machines. Additionally or alternatively, workflows may involve a worker manipulating hand tools or interacting with other workers.

Interfaces suitable for workflow assistance systems include conversational assistant interfaces. Conversational assistant interfaces are based on a user's voice and audition. Today multiple systems use this type of interface.

For example, European patent EP3454227A1 claims priority over an assistant that listens to the speech of a user and, by analyzing said speech, interprets the user's instructions within a context. Patent U.S. Ser. No. 10/956,666B2 refers to an assistant that generates text and voice responses in response to unstructured service requests from a user in natural language. In patent US20120265528A1, a virtual assistant uses context information to complement the natural language or gestural input of a user. Context information helps clarify user intents and reduce the space of possible interpretations of user input, and thus reduces the need for unnecessary clarification by the user. Patent WO2013116461A1 also describes a conversational intelligence to provide the user with context-dependent information. The intelligence relies on the context-dependent information to disambiguate the user's message.

Danish patent DK179745B1 claims priority over an environment to synchronize different instances of an assistant that responds to the requests made by a user, which is useful when a user can perform queries to the same type of assistant via several terminals. European patent EP3201913A4 claims priority over a similar assistant, which can receive successive speech requests from a user through different devices.

Depending on the degree of freedom granted to a user in accessing conversational assistants, a solution may be required to translate user requests into the instructions and formats of the multiple information systems in an organization. Solutions in this regard based on artificial intelligence are described in US patent U.S. Ser. No. 10/909,980B2 and European patent EP3642835A4. However, in production environments, giving users absolute freedom may be undesirable, interactions are usually strongly guided, and the information systems involved are predetermined.

US patent U.S. Ser. No. 10/055,681B2 describes an assistant that allows placing a user within a workflow and guiding him/her through said workflow by means of successive tasks to optimize objectives of the workflow.

A solution for end users to access information systems securely, in specific locations and times, is described in US patent U.S. Pat. No. 9,619,770B2.

None of the aforementioned patents claim functions or systems for estimating the performance of the workers or adjusting future interactions or establishing corrective measures by comparing the interactions and performances with those of different workers, or those of the same worker at different times and circumstances.

US patents U.S. Ser. No. 10/909,490B2 and US20200410414A1 propose a conversational assistant to estimate the performance of the workers. The assistant further predicts how the work of the organization will evolve from monitored voice interactions regarding transportation, materials' provisioning, and worker effort allocation aspects.

US patent US20170200108A1 proposes a system that estimates the performance of the workers in a logistics process by inferring their tasks and locations throughout the process from the analysis of dialogues. It calculates a set of worker efficiency metrics based on the number of picks the worker makes per unit of time. Then, it adjusts the tasks for each worker based on his/her estimated performance. The worker management system of US patent US20210117901 A1, which also includes a conversational assistant, also estimates the efficiency of the workers.

US patent US20160189076A1 considers the insertion of additional tasks in the normal workflow of a worker, while minimizing the interference with said workflow. The optimization of all the interactions of the worker as a whole, based on the knowledge accumulated by the system, is not considered.

The last five patents above do not take into account the degree of experience or efficiency of the workers in the past, nor cluster them automatically by performance levels. The systems proposed in the aforementioned patents do not decide how or in what order to present to the workers the different actions of a process based on the accumulated knowledge about the efficiency of the workers, either individually or in comparison with other workers. Further, the existing systems described in the prior patents do not factor in the accumulated knowledge about worker efficiency when performing tasks at different times or in different contexts.

For the reasons described above, known workflow assistance systems and supporting interfaces are not entirely satisfactory. Thus, there exists a need for novel workflow assistance systems that improve upon and advance the design of known workflow assistance systems. Examples of new and useful workflow assistance systems relevant to the needs existing in the field are discussed below.

Disclosure addressing one or more of the identified existing needs is provided in the detailed description below. Examples of references relevant to workflow assistance systems include EP3454227A1, U.S. Ser. No. 10/956,666B2, US20120265528A1, WO2013116461A1, DK179745B1, EP3201913A4, U.S. Ser. No. 10/909,980B2, EP3642835A4, U.S. Ser. No. 10/055,681B2, U.S. Pat. No. 9,619,770B2, U.S. Ser. No. 10/909,490B2, US20200410414A1, US20170200108A1, US20210117901A1, US20160189076A1. The complete disclosures of the above patents and patent applications are herein incorporated by reference for all purposes.

### SUMMARY

The present disclosure is directed to workflow assistance systems for a production process including a mobile terminal, a static terminal, a production management server, and a workflow server. The mobile terminal, the static terminal, the production management server, and the workflow server are in data communication with the data network.

The mobile terminal supports a first multimodal user interface of options for controlling operation of a production area. The first multimodal user interface provides instructions to a worker and receives instructions from the worker.

The static terminal supports a second multimodal user interface of options for controlling operation of the production area. The production management server runs production operations management software and provides instructions for the second multimodal user interface of the static terminal.

The workflow server executes workflow server instructions to determine workflow assistance instructions. The workflow assistance instructions assist the worker to operate the production area via the first multimodal user interface of the mobile terminal.

### BRIEF DESCRIPTION OF THE DRAWINGS

FIG. 1 is a schematic view of a first example of a workflow assistance system.

FIG. 2 is a flow diagram of the workflow assistance system shown in FIG. 1 registering an interaction of a worker with a multimodal user interface when performing an action in a production process.

FIG. 3 is a schematic view of a set of computer executable workflow server instructions utilized by an intelligent assistant of the workflow assistance system shown in FIG. 1.

FIG. 4 is schematic view of a computer executable instruction included in the instruction to assist a worker to select interface options shown in FIG. 3.

FIG. 5 is a schematic view of computer executable instructions included in the instruction to select preferred worker action data shown in FIG. 3.

FIG. 6 is a schematic view of additional or alternative computer executable instructions involved with the instruction to select preferred worker action data shown in FIG. 3.

FIG. 7 is a schematic view of additional or alternative computer executable instructions involved with the instruction to select preferred worker action data shown in FIG. 3.

FIG. 8 is a schematic view of additional or alternative computer executable workflow server instructions that may be utilized by the workflow assistance system shown in FIG. 1.

### DETAILED DESCRIPTION

The disclosed workflow assistance systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various workflow assistance systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including.” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Intelligent Workflow Assistance Systems for Production Processes

With reference to the figures, intelligent workflow assistance systems for production processes will now be described. The workflow assistance systems discussed herein function to improve performance of a worker in a production process. The reader will appreciate from the figures and description below that the presently disclosed workflow assistance systems address many of the shortcomings of conventional workflow assistance systems described above.

The workflow assistance systems interact with a worker through multimodal interfaces. The multimodal interfaces are based on voice channels, text, images, graphics, gestures, sounds and graphics, as well as tactile interactions. The multimodal interfaces are supported by a mobile terminal or additional external terminals located in the vicinity of a current point of the workflow. These external terminals can be connected to the mobile terminal of the worker either directly or through a shared network.

The workflow assistance systems monitor the specific interactions that the worker carries out through the different terminals and measure the efficiency of the worker in the execution of sequences of actions. An interaction involves the worker providing information to the workflow assistance system as inputs, and the worker receiving information from the workflow assistance system as outputs, through the aforementioned multimodal interfaces, supported by the aforementioned devices.

Through an automatic learning process, the workflow assistance systems decide the sequences of actions to propose to the worker. Further, the workflow assistance systems determine optimal terminals and interfaces to propose to the worker to perform his or her interactions. Additionally, the workflow assistance systems evaluate optimized options to present to the worker at the various interfaces at different points of the workflow.

The automatic learning process of the workflow assistance systems includes comparing the efficiency of more and less skilled workers. Further, the systems consider factors related to workers being active in different time slots, shifts, or days and to other objective circumstances. Moreover, the automatic learning process of the systems takes into account incidents and errors detected or predicted in a production process.

### Workflow Assistance System Embodiment One

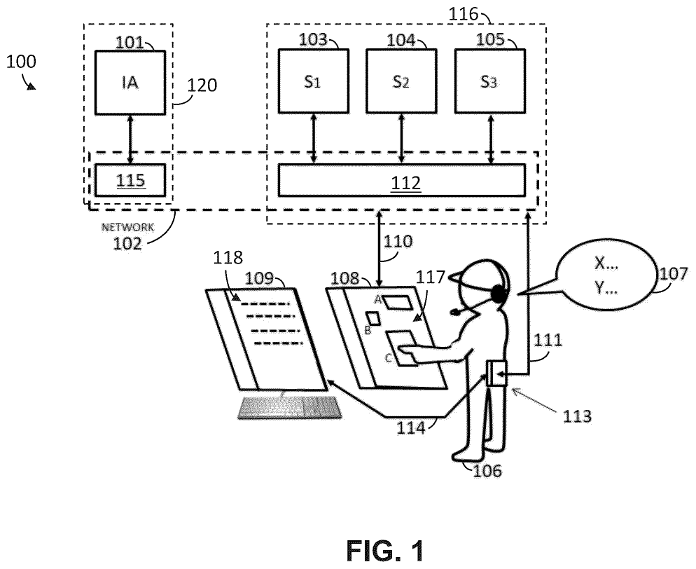

With reference to FIGS. 1-8, a first example of a workflow assistance system, workflow assistance system 100, will now be described. Workflow assistance system 100 functions to improve a production process by assisting workers to operate production areas of the production process more effectively, efficiently, and with fewer errors. Beneficially, workflow assistance system 100 utilizes worker experience data, worker interaction data, and action effectiveness data at different times to assist workers to select between user interface options for operating a production area and/or to assist workers to manually operate machines or tools in a production area.

Workflow assistance system 100 includes a mobile terminal 113, a first static terminal 108, a second static terminal 109, a data network 102, a production management server 116, and an intelligent assistant 120. In some examples, the workflow assistance system does not include one or more features included in workflow assistance system 100. For example, some workflow assistance system examples do not include a second static terminal. In other examples, the workflow assistance system includes additional or alternative features.

### Mobile Terminal

Mobile terminal 113 is a mobile computing device and is typically carried by a worker to different locations. As shown in FIG. 1, mobile terminal 113 is in data communication with data network 102. As schematically depicted in FIG. 1, mobile terminal 113 communicates data with network 102 through a wireless connection 111. However, the mobile terminal may communicate data with the data network via a wired connection as well.

Mobile terminal 113 enables a worker to interact with intelligent assistant 120 wherever the worker is located. In particular, mobile terminal 113 functions to provide the worker with assistance from intelligent assistant 120 for operating a given production area.

For example, the worker may carry mobile terminal 113 to different production areas in a production process and interact with intelligent assistant 120 in a given production area. Intelligent assistant 120 knows if a worker is currently at a point of the workflow, i.e., the production process, because the worker can be located using a location system, for example a location system based on QR codes, RFID, WLAN, or WPAN. Additionally or alternatively, the worker may carry mobile terminal 113 with him or her outside of production areas of a production process, such as an office, a break room, a conference room, or the worker's home, and interact with workflow assistance system 100 while away from the production process.

As shown in FIG. 1, mobile terminal 113 supports a first multimodal user interface 107. First multimodal user interface 107 presents the worker with options for controlling operation of a production area. In the present example, first multimodal user interface 107 is configured to provide instructions to the worker and to receive instructions from the worker. The first multimodal user interface and additional, related multimodal user interfaces are described in more detail below in the multimodal user interface section.

The mobile terminal may be any currently known or later developed type of mobile computing device. For example, the mobile terminal may be a laptop computer, a tablet, a smart phone, or a computing device specialized for a production process.

The workflow assistance system may include a single mobile terminal or multiple mobile terminals. In some examples with multiple workers, each worker carriers a mobile terminal. Any number of mobile terminals needed for a given application may be included in the workflow assistance system.

### Static Terminals

The static terminals function to control operation of production areas of a production process. For example, first static terminal 108 controls operation of a first production area and second static terminal 109 controls operation of a second production area. In some examples, one or more of the static terminals is adapted to control operation of more than one production area, such as multiple or all production areas in a production process.

The workflow assistance systems described herein are configured to accommodate any number of static terminals. Thus, the reader should appreciate that the workflow assistance system may include more or fewer than the two static terminals depicted in FIG. 1. In some examples, there is a single static terminal while in other examples there are three or more static terminals in the system.

The number of static terminals may correspond to the number of production areas in a production process or may be unrelated to the number of production areas. In examples where a static terminal is configured to control multiple production areas, the number of static terminals may be less than the number of production areas. However, some production areas may include more than one static terminal and the number of static terminals may exceed the number of production areas.

In the present example, first static terminal 108 is located proximate a first production area and second static terminal 109 is located proximate a second production area. However, the static terminals being located near production areas they control is not necessary or applicable in all scenarios. In some examples, a static terminal used to control a production area may be located remote from the production area.

The static terminals can be integrated into the data network or directly controlled by a worker's mobile terminal through a direct wireless connection. As shown in FIG. 1, first static terminal 108 includes an input/output device that communicates data with network 102 via a fixed connection 110. In the example shown in FIG. 1, second static terminal 109 communicates data with network 102 via a direct wireless connection 114 to mobile terminal 113, which is in data communication with network 102 through wireless connection 111.

The static terminals support multimodal user interfaces of options for controlling production areas. For example, as shown in FIG. 1, first static terminal 108 supports and presents a second multimodal user interface 117 and second static terminal 109 supports and presents a third multimodal user interface 118. The multimodal user interfaces are described in more detail in the multimodal user interface section below.

As depicted in FIG. 1, first static terminal 108 and second static terminal 109 are controllably coupled to production management server 116. Production operations management software running on production management server 116 provides instructions for second multimodal user interface 117 and for third multimodal user interface 118.

### Multimodal User Interfaces

The multimodal user interfaces enable a worker to interact with and receive assistance from intelligent assistant 120. Each multimodal user interface in workflow assistance system 100 provides access to automated assistance from intelligent assistant 120. However, the different multimodal user interfaces may be tailored to the device on which they are supported.

For example, as shown in FIG. 1, first multimodal user interface 107 operating on mobile terminal 113 is configured to facilitate conversational interaction with intelligent assistant 120, such as via voice or audition inputs. First multimodal user interface 107 may be programmed to locally interact conversationally with worker 106 or may utilize an external or remote module, for example a chatbot, to interpret the intentions of worker 106 conversationally. In the simplified example shown in FIG. 1, first multimodal user interface 107 includes options X and Y, but may include a wide variety of additional or alternative options.

In addition to enabling interaction with intelligent assistant 120, first multimodal user interface 107 enables worker 106 to control operation of a production area of a production process. First multimodal user interface 107 is configured to automatically present production area control options based on location data. For example, when worker 106 is proximate a first production area of a production process, first multimodal user interface 107 presents options relevant to controlling the first production area. Additionally or alternatively, worker 106 may select a given production area from first multimodal user interface 107 to cause first multimodal user interface 107 to present options for controlling the given production area selected manually.

With continued reference to FIG. 1, second multimodal user interface 117 supported on second static terminal 108 enables worker 106 to control operation of a production area of a production process. As shown in FIG. 1, second multimodal user interface 117 presents worker 106 with graphic options with which to interact via a touch screen. In the simplified example shown in FIG. 1, the graphic options presented by second multimodal user interface 117 includes options A-C, but may include a wide variety of other options.

In addition to enabling control of a production area, second multimodal user interface 117 is configured to enable worker 106 to interact with intelligent assistant 120. First static terminal 108 is located proximate to a first production area of a production process, so second multimodal user interface 117 displays options for controlling the first production area by default. However, worker 106 may additionally or alternatively select a given production area from second multimodal user interface 117 to instruct second multimodal user interface 117 to present options for controlling the given production area selected manually.

As depicted in FIG. 1, third multimodal user interface 118 on second static terminal 109 presents work with a text based interface. However, third multimodal user interface 118 is configured to enable interaction via conversational inputs or graphic touch screen options. For example, as shown in FIG. 1, mobile terminal 113 and second static terminal 109 are complementarily configured for mobile terminal 113 to directly expand its first multimodal user interface 107 onto second static text terminal 109 through direct wireless connection 114. Third multimodal user interface 118 enables worker 106 to interact with intelligent assistant 120 and to control a production area.

In workflow assistance system 100, worker 106 can interact with intelligent assistant 120 in a variety of ways. For example, worker 106 can interact with intelligent assistant 120 using the options of a voice/audition interface through first multimodal user interface 107. Additionally or alternatively, worker 106 can interact with intelligent assistant 120 via the graphic touch screen interface of second multimodal user interface 117 on first static device 108. Further, worker 106 can interact with intelligent assistant 120 using text based interface options of third multimodal user interface 118 on second static terminal 109.

### Data Network

As shown in FIG. 1, data network 102 facilitates data communication between different components of workflow assistance system 100. In particular, as depicted in FIG. 1, data network enables data communication between mobile terminal 113, first static terminal 108, second static terminal 109, production management server 116, and workflow server 115 of intelligent assistant 120. The components of workflow assistance system 100 communicate data with network 102 by a variety of different means.

For example, with continued reference to FIG. 1, mobile terminal 113 communicates data with network 102 through a wireless connection 111. First static terminal 108 includes an input/output device that communicates data with network 102 via a fixed connection 110. In the example shown in FIG. 1, second static terminal 109 communicates data with network 102 via a direct wireless connection 114 to mobile terminal 113, which is in data communication with network 102 through wireless connection 111. Production management server 116 and workflow server 115 communicate data with and over data network 102 via wired connections, but may utilized wireless data connections in other examples.

Any currently known or later developed means of exchanging data with and over the data network may be used. For example, the mobile terminal, the static terminals, the production management server, and the workflow server may each communicate data directly or indirectly with the data network over wired or wireless connections. The data network may utilize any currently known or later developed network protocols and interfaces. Further, the data network may facilitate data communication with any number of computing devices as needed for a given application of the workflow assistance system.

### Production Management Server

Production management server 116 functions to provide workflow assistance system 100 with access to stores of worker and production system data. Further, production management server 116 executes production operation management software to facilitate operating production areas of a production process.

Production management server 116 includes a physical computer programmable hardware, production management computer 112, which supports execution of computer executable instructions. While FIG. 1 schematically depicts a single production management computer 112, the reader should understand that the production management server may include a plurality of computing devices. Thus, production management computer 112 should be understood to represent one or more computing devices. The one or more computing devices may be located in different physical locations and in communication with each other over data network 102.

As can be seen in FIG. 1, production management server 116 includes a first information system 103, a second information system 104, and a third information system 105. While FIG. 1 schematically depicts three information systems, the production management computer may access and communication with a different number of information systems. In some examples, the production management computer accesses data from a single information system, two information systems, or more than three information systems. The number of information systems depicted in FIG. 1 is only intended to represent a multiplicity of information systems.

The instructions executed by production management computer 112 include production operation management software. The production operation management software enables accessing and sharing data with information systems 103-105 of a company. The production operation management software also provides instructions for controlling operation of production area via first, second, and third multimodal user interfaces 107, 117, and 118.

Suitable examples of production operation management software include Material Requirements Planning (MRP), Manufacturing Execution Systems (MES), and Manufacturing Operations Management (MOM) software. However, the production operation management software may be any currently known or later developed type of production operation management software.

### Intelligent Assistant

Intelligent assistant 120 is configured to determine and deliver workflow assistance instructions 125 to worker 106 via multimodal user interfaces 107, 117, and/or 118. Workflow assistance instructions 125 function to assist a worker to operate production areas more effectively, efficiently, and with fewer incidents. Intelligent assistant 120 is a product of workflow server 115 executing workflow server instructions 101. Workflow server 115 and workflow server instructions 101 are described in more detail in the corresponding sections below.

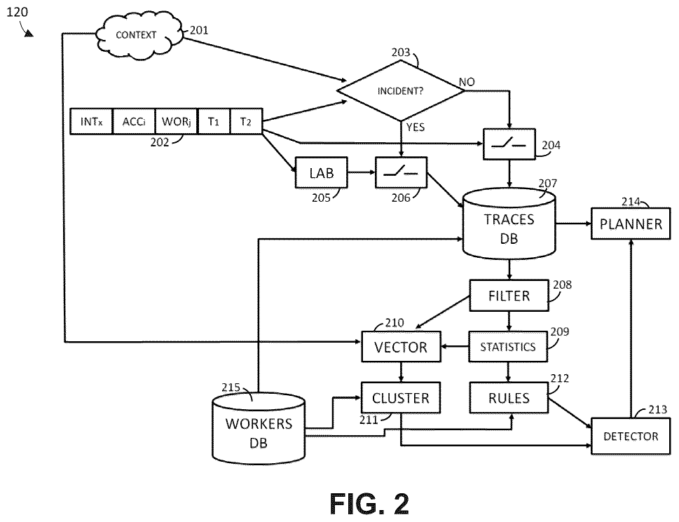

With reference to FIG. 2, an example of intelligent assistant 120 registering a new interaction of a worker will be described. At step 202, FIG. 2 schematically depicts intelligent assistant 120 registering a new interaction INTx of worker WORj between instants T1 and T2 when the worker performs action ACCi. This interaction can correspond to a selection of an option of an interface by the worker, a manipulation of a machine by the worker, or any other interaction in the production process by the worker.

Available context information 201 is used by intelligent assistant 120 to detect if new interaction INTx is related to an incident at step 203. If intelligent assistant 120 determines that new interaction INTx corresponds to an incident at step 203, then intelligent assistant 120 labels new interaction INTx with an incident identifier 205 at step 206 prior to saving the interaction data in a trace database 207. If new interaction INTx is determined to not be an incident at step 203, then intelligent assistant 120 does not label it as an incident and passes the new interaction data along at step 204 to be saved in trace database 207 without an incident identifier.

Registered information is saved in traces database 207. As shown in FIG. 2, registered information in traces database 207 may be filtered by selection criteria 208. Whether or not the registered information is filtered by selection criteria 208, intelligent assistant 120 may calculate workers' statistics at step 209.

The workers' statistics can be checked with fixed rules at step 212. Additionally or alternatively, the workers' statistics may be passed, once organized as vectors at step 210, to a similarity algorithm, for example a clustering algorithm, at step 211. Clustering algorithm or any other efficiency revealing algorithm may be used to detect the most efficient workers at step 213.

Intelligent assistant 120 may access worker identities from a workers' database 215. Utilizing a planner 214, intelligent assistant 120 can use worker identity data from workers' database 215 and corresponding traces of the most efficient workers from traces database 207 as an input to plan worker action sequences to propose and the options via the interfaces available to assist a worker to select to effectuate the proposed worker action sequences.

Intelligent assistant 120 may find particular benefit when proposing actions and assisting with interface option selection to less efficient workers. That is, a differential aspect of intelligent assistant 120 is the ability to codify expert knowledge of the most efficient workers to guide the actions of less efficient workers, such as inexperienced workers.

Multiple different sources of information may be considered by workflow server 115 when executing workflow server instructions 101. The different sources of information are used to generate various workflow assistance instructions 125 to assist different workers in different capacities and circumstances. For example, at any point of the workflow, at different times, the level of efficiency of the workers will vary. For instance, different workers will be more or less experienced and may rely on intelligent assistant 120 to different degrees.

The most efficient workers will take the initiative and tend to control the interactions with intelligent assistant 120. For example, more experienced workers may tend to indicate their desire to enter data or perform a specific action whenever they consider it most appropriate. On the other hand, less efficient workers, such as inexperienced workers, may tend to strictly follow workflow assistance instructions 125 of intelligent assistant 120 by performing the actions that are associated to the current point in the sequence that intelligent assistant 120 indicates.

Further, the most efficient workers will tend to be more diligent in the execution of their actions, carrying the same sets of actions (but not necessarily ordered in the same sequence) in less time than the less efficient workers, and choosing optimal combinations of options at the user interfaces. In general, a more efficient worker will tend to order the actions to be carried out at a point of the workflow in the sequence that he or she considers convenient, choosing particular options of the interfaces available to perform his/her interactions.

In addition, regardless of their level of efficiency, all workers may make mistakes or may experience issues beyond their control. Some of these incidents will lead to the voluntary repetition of actions. Other incidents will generate system behaviors outside a normality range. An example of an incident is a worker entering a measurement of a parameter out of a range given by maximum and minimum known values that determine said range. Another example of an incident is a sensor detecting that a part is incorrectly positioned or that one of the dimensions of a produced part is incorrect.

Incidents can therefore be detected by means of rules and comparisons with context information accessed by intelligent assistant 120. For example, FIG. 2 schematically depicts intelligent assistant 120 utilizing stored context information 201 to detect incidents at step 203.

Intelligent assistant 120 is programmed to discriminate between workers with different levels of efficiency at step 213 in various ways. For example, intelligent assistant 120 includes workflow server instructions 101 to consider the time workers take to execute the same set of actions at step 212. Further at step 212, intelligent assistant 120 considers the degree of initiative of the worker. The degree of initiative is the number of actions in which the worker invokes intelligent assistant 120 versus the number of actions in which intelligent assistant 120 guides the worker with workflow assistance instructions 125.

By encoding the behavior of the workers in vectors of a vector space, meaningful assessments of efficiency and optimized worker action can be made. The vector space dimensions will correspond to various variables. Suitable vector space variables include statistics of the interactions of the workers 209, the options they choose through different multimodal user interfaces 107, 117, and 118, their timings, the actions they perform and other context information 201.

Grouping the workers by means of a proximity algorithm in vector space 211 helps identify effective and efficient sequences of worker actions. For example, clustering algorithms can be used to reveal sets (clusters) of vectors 210 similar to those of the most efficient workers (those who complete their actions in less time). Vectors similar to the most efficient workers are defined to be representative of the most efficient sequences of actions and selections of interface options. Efficient workers whose vectors are close in the vector space will be assumed to perform a set of actions in the most appropriate way, with the most adequate interface options, through the interfaces available.

Another way that intelligent assistant 120 is configured to discriminate between workers with different levels of efficiency at step 213 is to factor in the number of incidents related to a worker at step 203. Further, intelligent assistant 120 includes workflow server instructions 101 to exclude from the analysis, totally or partially, actions or interactions of workers that coincide in the same time interval with an error or incident at filtering step 208.

A further means for intelligent assistant 120 to discriminate between workers with different levels of efficiency at step 213 is based on direct knowledge stored in databases 215 within production management server 116. For example, the production management server databases 215 may include data corresponding to worker identifiers associated with a level of experience or work category. Further, trace database 207 provides data on traces of worker actions and interactions. Intelligent assistant 120 may also compare workers in different shifts, days or any other time intervals, where their work shifts can be consulted in enterprise databases 215.

To encode the expert knowledge of the most efficient workers to guide the actions of the other workers, intelligent assistant 120 analyzes the sequences of actions of the most effective workers and the options they choose through the different multimodal user interfaces available. Intelligent assistant 120 is programmed to use the most effective worker actions and options chosen as references for a planner 214 (a module utilized by workflow server 115) to propose sequences of actions and interface options in workflow assistance instructions 125. Often, intelligent assistant 120 proposes action and interface option sequences to less efficient workers, such as inexperienced workers, at each point in the workflow. In other words, intelligent assistant 120 is configured to choose the order of the actions and interface options that correspond to the workers who have completed those actions in less overall time and with fewer errors.

The different interactions of a worker with multimodal user interfaces 107, 117, or 118 on one or more of the terminals 113, 108, and 109 are associated to specific actions he or she performs at the points of the workflow. Registered worker data, depicted schematically at 202, 205, and 207 in FIG. 2, includes the effect of the worker's action on the company's systems, his or her interactions through the interfaces available, as well any other interaction with the production systems. These data can be registered as tuples 202 that, in addition to the aforementioned information, may also contain the initial and final instants (T1 and T2 in FIG. 2) of the interval during which an interaction takes place.

Context information 201 may consist of numerical ranges with which to compare information entered by the worker, measurements of parts, or sensor readings during the interactions of the workers. Through the context information, by means of simple comparisons with known normality ranges, intelligent assistant 120 is programmed to discern if a tuple is associated with an incident 203. If an incident is detected, incident case logic 206 in FIG. 2, the tuple is labeled as with an incident identifier 205 prior to storing the tuple in a traces database 207. If an incident is not detected, no incident case logic 204 in FIG. 2, the tuple may be directly stored in tuple database 207 without an incident identifier.

Intelligent assistant 120 may filter the traces of the database at step 208 to discard the tuples corresponding to workers, interactions or actions related to incidents in given time intervals, repeated tuples, incomplete tuples, or any tuples that satisfy rules preset by the organization. Whether or not such filters are applied, worker statistics 209 can be calculated, such as the mean, median, minimum, or maximum, as well as the standard deviation, of any quantitative or temporal measure of any interaction or action.

All registered worker data and derived statistics can be compared with previous data of the worker or other workers. The comparisons may be made by means of rules 212. Additionally or alternatively, the data organized in vectors 210 of a vector space, may be passed along with selected context information 201 to a clustering algorithm 211, for example K-Means algorithm. The clustering algorithm may be used by intelligent assistant 120 to detect patterns that correspond to the most efficient workers 213.

In this vectorization, successive groups of components of a vector may correspond to different actions or interactions of a worker or the different time intervals when they take place. The most efficient workers are considered to be those for which certain statistics fulfill a numerical rule, or those that are part of a cluster whose sequences of actions and interactions through the options of the interfaces available have typically been completed faster than those of other clusters.

The sequences of actions of the most efficient workers and the options they select through the interfaces available 207 are used by intelligent assistant 120 as a model to plan the sequences of actions and the interface options through the interfaces available 214 to propose to other workers at the different points of the workflow.

For example, intelligent assistant 120 may propose recommended action and interface option sequences to less experienced workers to improve their performance in the production process. Additionally or alternatively, other synthetic sequences of actions and interface options that result from the application of process mining to the sequences of actions and the interface options of the groups of the most efficient workers can be used by intelligent assistant 120 to determine sequences of actions and the interface options through the interfaces available 214 to propose to other workers, such as less efficient workers, at the different points of the workflow.

### Workflow Server

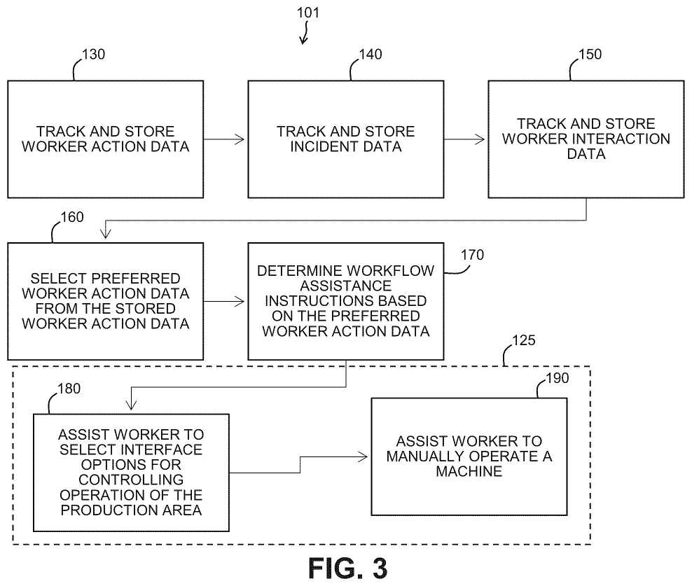

Workflow server 115 supports execution of workflow server instructions 101. As shown in FIG. 3, workflow server 115 executing workflow server instructions 101 enables workflow server 115 to determine workflow assistance instructions 125. Workflow assistance instructions 125 function to assist a worker to operate production areas more effectively, efficiently, and with fewer incidents.

With reference to FIGS. 1 and 3-5, workflow server 115 is configured to execute workflow server instructions 101 to determine workflow assistance instructions 125. Workflow assistance instructions 125 are presented to a worker via one or more multimodal user interfaces, for example, multimodal interfaces 107, 117, and/or 118.

In the present example, workflow server 115 includes computer programmable hardware as physical support for workflow server instructions 101 and workflow assistance instructions 125. As shown in FIG. 1, workflow server 115 communicates with production management server 116 over data network 102. Further, workflow server 115 is controllably coupled to mobile terminal 113, to first static terminal 108, and to second static terminal 109 via data network 102.

### Workflow Server Instructions and Workflow Assistance Instructions

Workflow server instructions 101 function to generate workflow assistance instructions 125 utilizing various data sources relevant to a production process. Workflow assistance instructions 125 function to propose to workers sequences of actions to be carried out at the different points of a workflow and the options of the user interfaces of the devices at those points.

As shown in FIGS. 1 and 3, workflow server instructions 101 define a computer program that runs on programmable hardware included in workflow server 115. Intelligent assistant 120 is a product of workflow server 115 executing workflow server instructions 101 and determining workflow assistance instructions 125 to be presented to a worker via multimodal user interfaces.

Workflow assistance instructions 125 include instructions for assisting a worker to operate a production area. In the present example, workflow assistance instructions serve to assist the worker a via first multimodal user interface 107 of mobile terminal 113, via second multimodal user interface 117 of first static terminal 108, or via third multimodal user interface 118 of second static terminal 109. In general, the workflow assistance instructions can initiate and/or define interactions with the worker using the options of the interfaces of any of the aforementioned devices, screens or terminals of the workflow assistance system.

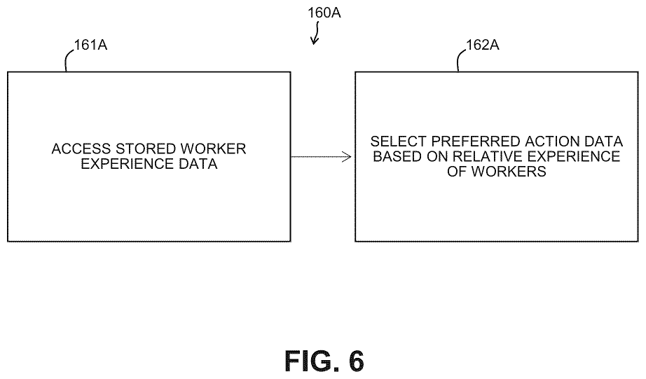

FIGS. 3-5 schematically depict computer executable steps included in workflow server instructions 101. Further, FIGS. 6-8 schematically depict additional or alternative steps that may be included in the workflow server instructions. The following paragraphs will summarize the instructions included in workflow server instructions 101 and executed by workflow server 115 to provide worker 106 with workflow assistance instructions 125 via intelligent assistant 120.

As shown in FIG. 3, workflow server instructions 101 include an instruction 130 to track and store worker action data. Instruction 130 may be referred to as workflow monitoring instructions.

The worker action data include the actions of the worker in the production process. In examples where multiple workers are involved with controlling operation of a production process, the worker action data includes the actions of each worker in the production process or a selected subset of the workers in the production process.

In the present example, the worker action data includes the sequence of actions undertaken by the worker in the production process. The sequence of actions undertaken by the worker may include the worker's sequence of interactions with a multimodal user interface, including first multimodal user interface 107, second multimodal user interface 117, and third multimodal user interface 118.

Instruction 140 of workflow server instructions 101 is to track and store incident data. When executing instruction 150, workflow server 115 tracks and stores worker interaction data.

With continued reference to FIG. 3, instruction 160 of workflow server instructions 101 is to select preferred worker action data from the stored worker action data. Workflow server 115 may access stored worker data pursuant to instruction 160 from production management server 116 over data network 102.

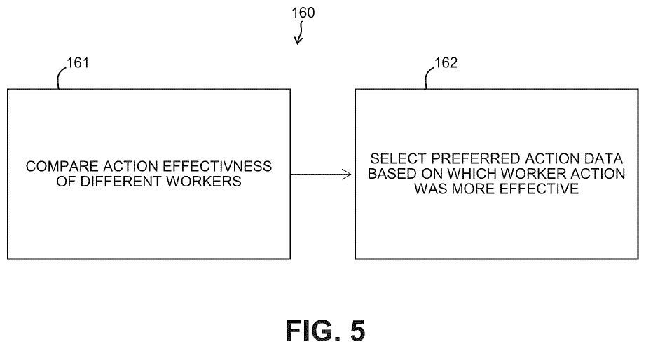

As shown in FIG. 5, instruction 160 includes an instruction 161 to compare the effectiveness of worker action data from different workers. More specifically, instruction 161 includes identifying whether actions of a given worker in the stored worker action data were more effective in the production process than actions of another worker. With further reference to FIG. 5, instruction 160 further includes an instruction 162 to select preferred action data based on which worker action was more effective.

In some instances, worker incident data related to worker actions is considered by workflow server 115 when selecting preferred worker action data. For example, the workflow monitoring instructions may include an instruction to track and store incident data for actions taken by the worker or workers in a production process. The incident data identifies if an action did not satisfy specified parameters for a production process. In the present example, as depicted in FIG. 1, workflow server 115 tracks and stores incident data in cooperation with production management server 116 over data network 102. When incident data is tracked and stored, the workflow server instructions may include an instruction to select preferred worker action data based at least in part on the stored incident data.

With reference to FIG. 6, the reader can see details of an additional or alternative instruction 160A involving selecting preferred worker action data from the stored worker experience data. As shown in FIG. 6, instruction 160A includes an instruction 161A to access stored worker experience data. As depicted in FIG. 1, workflow server 115 may access stored worker experience data pursuant to instruction 161A from production management server 116 over data network 102. With reference again to FIG. 6, instruction 160A includes an instruction 162A to select the preferred worker action data based on the relative experience of the workers included in the worker experience data accessed in step 161A.

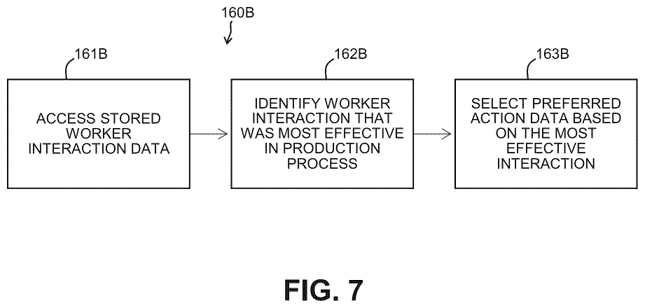

Referencing FIG. 7, the reader can see details of an additional or alternative instruction 160B involving selecting preferred worker action data from the stored interaction data. As shown in FIG. 7, instruction 160B includes an instruction 161B to access stored worker interaction data. In the present example, as depicted in FIG. 1, workflow server 115 accesses stored worker interaction data from production management server 116 over data network 102 when executing instruction 161B.

The worker interaction data includes the interactions of worker 106 with one or more of mobile terminal 113, first static terminal 108, and second static terminal 109. In particular, the worker interaction data includes the interactions of worker 106 with one or more of first multimodal user interface 107, second multimodal user interface 117, and third multimodal user interface 118. When multiple workers are involved with a production process, the worker interaction data includes the interactions of each worker with mobile or static terminals utilized by the workers and the multimodal user interfaces supported by each terminal.

In some examples, the workflow monitoring instructions include instructions to track and store incident data for interactions with a multimodal user interface made by a worker. The incident data identifies that an interaction caused an action outside specified parameters. Workflow server 115 may track and store incident data in cooperation with production management server 116 via data network 102. When incident data is tracked and stored, the workflow server instructions may include instructions for selecting preferred worker interaction data based at least in part on the stored incident data.

In certain examples, the workflow monitoring instructions include instructions to access worker efficiency data for workers involved in a production process. The worker experience data may include a worker's tenure in a position, number of instances operating a production area, credentials, and other indicators of competency. Workflow server 115 may access worker efficiency data stored in production management server 116 via data network 102. When worker efficiency data is accessed by workflow server 115, the workflow server instructions may include instructions for selecting preferred worker interaction data based at least in part on the stored worker efficiency data.

Referring again to FIG. 7, instruction 160B includes an instruction 162B to identify the worker interaction that was most effective in the production process. Workflow server 115 then executes instruction 163B depicted in FIG. 7 to select preferred action data based at least in part on the worker interaction deemed most effective in instruction 162B.

When executing instruction 170, workflow server 115 determines workflow assistance instructions 125 based on the preferred worker action data.

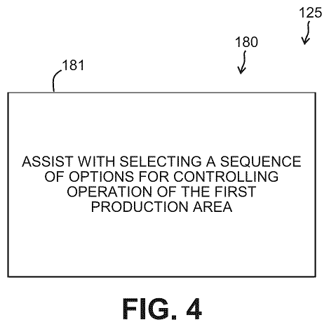

As shown in FIG. 3, instruction 180 is to assist a worker to select interface options for controlling operation of the production area based on workflow assistance instructions 125 determined in step 170. With instruction 180, intelligent assistant 120 may assist worker 106 to control operation of the production area via first, second, or third multimodal user interfaces 107, 117, or 118 by coaching or guiding worker 106 to select particular options presented on those multimodal user interfaces. With reference to FIG. 4, the reader can see that instruction 180 of workflow assistance instructions 125 includes an instruction 181 to assist the worker to select a sequence of options presented on one or more of first, second, or third multimodal user interfaces 107, 117, or 118 for controlling operation of the first production area.

Instruction 190 is to assist the worker to manually operate a machine based on workflow assistance instructions 125 determined in step 170. The reader will understand that instruction 190 is not executed when a production area does not include a machine intended to be manually operated by a worker. Worker 106 may receive the assistance with manually operating a machine from intelligent assistant 120 as prompts, guides, or directions via one or more of the multimodal user interfaces 107, 117, and 118.

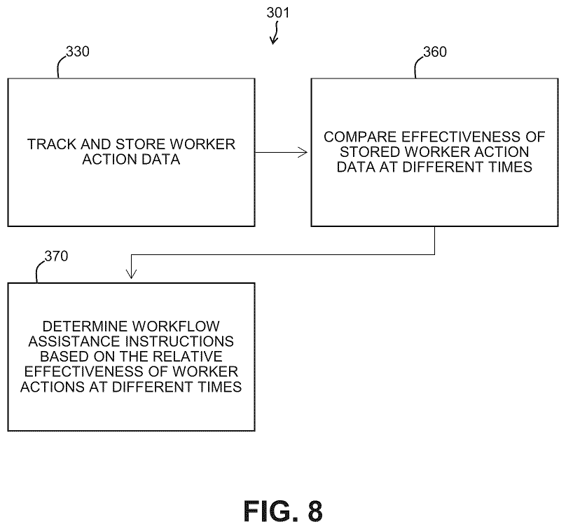

Turning attention to FIG. 8, an additional or alternative set of workflow server instructions 301 will be described. As schematically shown in FIG. 8, workflow server instructions 301 include an instruction 330 to track and store worker action data. Workflow server 115 may track and store worker action in cooperation with production management server 116 over data network 102 as depicted in FIG. 1.

With returned focus to FIG. 8, workflow server instructions 301 include an instruction 360 to compare the effectiveness of stored worker action data at different times. Different times in this context means the different times worker actions were performed rather than workflow server 115 undertaking at different times a comparison of worker action data.

In one example, a first worker action at a first time, such as during a day-shift, is compared to the first worker's action at a second time, such as during a night-shift. Comparing the same worker's action at different times can help the system to assess whether the worker action is more effective or efficient at a particular time. In another example, actions from a group of workers at approximately the same first time, such as actions by various day-shift crew members, are compared to actions by a group of different workers at approximately a same second time, such as actions by various night-shift crew members. Comparing different workers' actions at different times can yield information regarding whether actions performed at a particular time is more effective and efficient regardless of the worker performing the action.

As depicted in FIG. 8, workflow server instructions 301 include an instruction 370 to determine workflow assistance instructions based on the relative effectiveness of worker actions at different times. Determining workflow assistance instructions for a given action based on the results of the given action at different times in the stored worker action data has been observed to yield more effective and efficient instructions for a worker to follow.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A workflow assistance system for a production process, comprising:
a mobile terminal carried by a worker to different production areas of the production process and supporting a first multimodal user interface of options for controlling operation of the first production area, the first multimodal user interface being configured to provide instructions to the worker and to receive instructions from the worker, the mobile terminal being in data communication with a data network;
a static terminal located proximate a first production area of the production process and supporting a second multimodal user interface of options for controlling operation of the first production area, the static terminal being in data communication with the data network;
a production management server running production operations management software in data communication with the data network, the production management server being controllably coupled to the static terminal and the production operations management software providing instructions for the second multimodal user interface of the static terminal; and
a workflow server configured to execute workflow server instructions, the workflow server being in data communication with the data network and controllably coupled to the mobile terminal and to the static terminal;
wherein the workflow server executing the workflow server instructions determines workflow assistance instructions for assisting the worker to operate the first production area via the first multimodal user interface of the mobile terminal.

2. The workflow assistance system of claim 1, wherein the workflow assistance instructions include an instruction to assist the worker to select between the options for controlling operation of the first production area through one or more of the first multimodal user interface and the second multimodal user interface.

3. The workflow assistance system of claim 2, wherein the workflow assistance instructions include an instruction to assist the worker to select a sequence of options for controlling operation of the first production area.

4. The workflow assistance system of claim 1, wherein:
the first production area includes a machine configured to be manually operated by the worker; and
the workflow assistance instructions include instructions for assisting the worker to manually operate the machine.

5. The workflow assistance system of claim 1, wherein:
the workflow server instructions include workflow monitoring instructions;
the workflow monitoring instructions include instructions to track and store worker action data; and
the worker action data includes the actions of the worker in the production process.

6. The workflow assistance system of claim 5, wherein the worker action data includes the sequence of actions of the worker in the production process.

7. The workflow assistance system of claim 6, wherein the worker action data includes the sequence of interactions with one or more of the first multimodal user interface and the second multimodal user interface.

8. The workflow assistance system of claim 5, wherein:
the worker is a first worker; and
the worker action data includes the actions of the first worker and a second worker in the production process.

9. The workflow assistance system of claim 8, wherein:
the workflow server instructions include instructions for selecting preferred worker action data from the stored worker action data; and
the workflow server instructions include instructions for determining the workflow assistance instructions based on the preferred worker action data.

10. The workflow assistance system of claim 9, wherein:
the workflow server instructions include instructions for identifying whether actions of the first worker or the second worker in the stored worker action data were more effective in the production process; and
the preferred worker action data is selected based at least in part on the actions deemed more effective in the production process.

11. The workflow assistance system of claim 9, wherein:
the workflow server instructions include instructions for accessing stored worker experience data for the first worker and the second worker; and
the preferred worker action data is selected based at least in part on the experience of the first worker compared to the second worker.

12. The workflow assistance system of claim 9, wherein:
the workflow monitoring instructions include instructions to track and store incident data for actions taken by the first worker and by the second worker;
the incident data identifies if an action did not satisfy specified parameters; and
the workflow server instructions include instructions for selecting the preferred worker action data based at least in part on the stored incident data.

13. The workflow assistance system of claim 5, wherein:
the workflow monitoring instructions include instructions to track and store worker interaction data; and
the worker interaction data includes the interactions of the worker with one or more of the mobile terminal and the static terminal.

14. The workflow assistance system of claim 13, wherein:
the mobile terminal defines a first mobile terminal carried by a first worker;
the workflow assistance system further comprises a second mobile terminal carried by a second worker; and
the worker interaction data includes the interactions of the first worker and the second worker with one or more of the first mobile terminal, the second mobile terminal, and the static terminal.

15. The workflow assistance system of claim 14, wherein:
the workflow server instructions include instructions for selecting preferred worker interaction data from the stored worker interaction data; and
the workflow server instructions include instructions for determining the workflow assistance instructions based on the preferred worker interaction data.

16. The workflow assistance system of claim 15 wherein:
the workflow server instructions include instructions for identifying whether interactions of the first worker or the second worker in the stored worker interaction data were more effective in the production process; and
the preferred worker interaction data is selected based at least in part on the interactions deemed more effective in the production process.

17. The workflow assistance system of claim 15, wherein:
the workflow server instructions include instructions for accessing stored worker experience data for the first worker and the second worker; and
the preferred worker interaction data is selected based at least in part on the experience of the first worker compared to the second worker.

18. The workflow assistance system of claim 15 wherein:
the workflow server instructions include instructions for accessing stored worker efficiency data for the first worker and the second worker, and
the preferred worker interaction data is selected based at least in part on the efficiency of the first worker compared to the second worker.

19. The workflow assistance system of claim 15, wherein:
the workflow monitoring instructions include instructions to track and store incident data for interactions made by the first worker and by the second worker;
the incident data identifies that an interaction caused an action outside specified parameters; and
the workflow server instructions include instructions for selecting the preferred worker interaction data based at least in part on the stored incident data.

20. The workflow assistance system of claim 5, wherein:
the stored worker action data includes the results of a given action taken by the worker at different times; and
the workflow server instructions include instructions for determining the workflow assistance instructions related to the given action based on the results of the given action at different times in the stored worker action data.
